(19) United States
(12) Patent Application Publication
(10) Pub. No.: US 2009/0216448 A1
(43) Pub. Date: Aug. 27, 2009

(54) GLOBAL POSITIONING SYSTEM NAVIGATION APPARATUS AND POSITIONING METHOD THEREOF

(75) Inventor: Chin-Shun Chang, Taipei County (TW)

Correspondence Address: J C PATENTS, INC., 4 VENTURE, SUITE 250, IRVINE, CA, 92618, US

(73) Assignee: KINPO ELECTRONICS, INC., Taipei County (TW)

(21) Appl. No.: 12/170,107

(22) Filed: Jul. 9, 2008

(30) Foreign Application Priority Data
Feb. 26, 2008 (TW) 97106643

(51) Int. Cl. G01C 21/00

(52) U.S. Cl. 701/214; 701/213

(57) ABSTRACT

A Global Positioning System (GPS) navigation apparatus and a positioning method thereof are provided. The GPS navigation apparatus includes a GPS module and a data processing unit. When the GPS module enters into an operation mode from a standby mode, the GPS module starts to output a positioning data. The data processing unit calculates a present position according to the positioning data from the GPS module after a predetermined time interval since the GPS module enters into the operation mode, so as to reduce a positioning error.

### CROSS-REFERENCE TO RELATED APPLICATION

This application claims the priority benefit of Taiwan application serial no. 97106643, filed on Feb. 26, 2008. The entirety of the above-mentioned patent application is hereby incorporated by reference herein and made a part of this specification.

### BACKGROUND OF THE INVENTION

1. Field of the Invention

The present invention generally relates to global positioning system (GPS) navigation apparatuses, and more particularly, to a GPS navigation apparatus adapted for reducing a position shift from occurring at a beginning of the positioning operation.

2. Description of Related Art

GPS is a technology combining space satellite techniques and communication techniques. GPS was first developed for military purpose only. For example, GPS is often equipped in military aircrafts, military ships, military vehicles, and military personnel for accurately positioning attacking targets. Nowadays, GPS is also being provided for civil use. Ever-since, GPS technology has been drastically developed. Specifically, vehicle GPS navigation apparatuses are now very widely used and capable of not only accurately positioning, but also provide accurate information such as velocity, time, direction, and distance.

A typical GPS navigation apparatus is featured in calculating its own position referring to positions of satellites. When a satellite is moving, at any time, there would be a coordinate value corresponding to its position. Generally, the coordinate is provided as a known value. Data of the satellite takes time for transmitting to a receiver of the user of the GPS navigation apparatus and the time relates to the transmitting distance therebetween. Therefore, the distance from the satellite to the receiver can be calculated by comparing a clock of the satellite with an internal clock of the receiver. In such a way, a corresponding equation is provided according to a triangular vector relationship thereof, the position of the GPS navigation apparatus can be obtained.

However, at the beginning of initiating the GPS navigation apparatus, a position shift may occur due to signal misjudgment or the GPS module being not ready for regular operation yet. When information containing such a position shift is provided to those needing to record a moving track, e.g., climbers, it may lead to a misjudgment, according to which the climbers may select an incorrect route.

### SUMMARY OF THE INVENTION

Accordingly, the present invention is directed to a GPS navigation apparatus including a GPS module. The GPS navigation apparatus is adapted to delete or filter positioning data, also known as National Marine Electronics Association (NMEA) message, outputted by the GPS module at a beginning of entering an operation mode, and directly fetch positioning data outputted by the GPS module after a predetermined time interval since the GPS module enters into the operation mode for positioning, and whereby to improve the position shift.

The present invention is also directed to a method for depressing a position shift. The method filters or deletes positioning data outputted by a GPS module in first several seconds after the GPS module is just initialized or enters into an operation mode. Positioning data outputted thereafter is then fetched for improving the position shift.

Accordingly, the present invention provides a global positioning system (GPS) navigation apparatus including a GPS module and a data processing unit. When the GPS module enters from a standby mode into an operation mode, the GPS module receives a satellite positioning signal and outputs a positioning data from a first time. The data processing unit is coupled to the GPS module, and is adapted to calculate a present position according to a positioning data outputted after a second time by the GPS module. The second time occurs after the first time, and there is a predetermined time interval between the first time and the second time.

According to an embodiment of the present invention, the data processing unit includes a register, a data filtering unit, and a conversion unit. The register is provided for storing the positioning data therein. The data filtering unit is coupled to the register for reading and outputting the positioning data outputted by the GPS module after the second time. The conversion unit is coupled to the data filtering unit for calculating the present position according to the positioning data outputted from the data filtering unit.

According to an embodiment of the present invention, the data processing unit further includes a system error detecting unit coupled between the GPS module and the register for calibrating the GPS module and adjusting a transmission rate of the position data, e.g., baud rate.

According to an embodiment of the present invention, the method for depressing a position shift and the positioning apparatus thereof are also adapted for a mobile communication apparatus, e.g., a cell phone.

According to an embodiment of the present invention, the predetermined time interval is longer than 3 seconds. According to an embodiment of the present invention, a format of the positioning data matches a National Marine Electronics Association (NMEA) communication protocol.

According to an embodiment of the present invention, the navigation apparatus further includes a display unit adapted for displaying a positioning picture according to the present position.

According to another aspect of the present invention, a positioning method for depressing a position shift for a GPS navigation apparatus is provided. The positioning method includes the following steps. When the navigation apparatus enters into an operation mode from a standby mode, a satellite positioning signal is received and a positioning data is output starting from a first time. Next, the positioning data is stored. Next, positioning data is read and outputted from the navigation apparatus after a second time, wherein the second time occurs after the first time, and there is a predetermined time interval between the first time and the second time. Next, a present position is calculated according to the positioning data outputted from the navigation apparatus after the second time.

According to an embodiment of the present invention, the positioning method further includes the steps of calibrating the positioning data outputted from the navigation apparatus; and adjusting a transmitting rate of the positioning data.

Because the positioning data outputted from the navigation apparatus when the GPS module just enters the operation mode or is just initialized is ignored, and positioning data outputted is directly fetched after several seconds for calculating the present position, therefore the possibility of a position shift occurring at a beginning of the positioning operation may be effectively reduced. It should be noted that the present invention may be modified using appropriate software, and thus does not require changing the hardware configuration.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is block diagram illustrating a GPS navigation apparatus according to a first embodiment of the present invention.

FIG. 2 is a flow chart illustrating a positioning method according to a second embodiment of the present invention.

FIG. 3 shows schematic views illustrating the position shift according to the embodiments of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

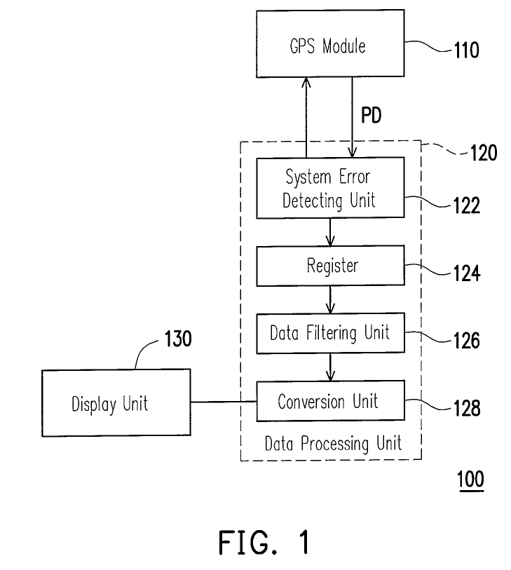

FIG. 1 is block diagram illustrating a GPS navigation apparatus according to a first embodiment of the present invention. Referring to FIG. 1, a navigation apparatus 100 includes a GPS module 110, a data processing unit 120 and a display unit 130. The data processing unit 120 further includes a system error detecting unit 122, a register 124, a data filtering unit 126, and a conversion unit 128. The system error detecting unit 122 is coupled between the GPS module 110 and the register 124. The data filtering unit 126 is coupled between the conversion unit 128 and the register 124. The display unit 130 is coupled to the conversion unit 128.

When the GPS module 110 enters into an operation mode from a standby mode, it receives a satellite positioning signal and outputs a positioning data PD, which is also known as a National Marine Electronics Association (NMEA) message. The system error detecting unit 122 is adapted for calibrating the GPS module and adjusting a transmitting rate of the positioning data PD (baud rate). When the GPS module is calibrated, or its transmitting rate is correct, the system error detecting unit 122 allows the GPS module 110 to temporarily store the positioning data PD into the register 124. If the GPS module 110 starts to output the positioning data PD from a first time, the data filtering unit 126 reads and output positioning data outputted after a second time by the GPS module 110. The second time occurs later than the first time, and there is a predetermined time interval between the first time and the second time, for example 3 seconds or 5 seconds. A user may set the predetermined time interval in accordance with a desired positioning accuracy. Generally, a longer predetermined time interval corresponds to a higher positioning accuracy. The conversion unit 128 is adapted for calculating the present position of the navigation apparatus 100 according to the positioning data PD outputted from the data filtering unit 126. The display unit 130 is adapted to display a positioning picture according to the present position.

In other words, when the navigation apparatus 100 enters into the operation mode from the standby mode, the data processing unit 120 filters away the positioning data PD outputted during a predetermined time interval by the GPS module 110, and after the navigation apparatus 100 achieves a stable operation status, the positioning data PD outputted thereafter are fetched for positioning calculation to obtain the accurate position of the navigation apparatus 100. That is, the positioning data PD fetched by the data processing unit 120 is outputted by the navigation apparatus 100 after a predetermined time interval since the navigation apparatus 100 enters into the operation mode.

Because at the beginning of entering into the operation mode, the positioning data PD outputted from the navigation apparatus 100 is relatively inaccurate, a position shift may be produced by directly adopting such a positioning data for performing a positioning calculation. As such, the current embodiment neglects the positioning data PD outputted in the first several seconds since the GPS module enters into the operation mode, and directly fetches positioning data PD outputted after the first several seconds for positioning calculation, so as to reduce the possibility of producing an incorrect positioning information. In practice, it is preferred to directly fetch a positioning data PD after 3 seconds, an error corresponding thereto may be lowered to less than 10 meters. Generally, a longer predetermined time interval time corresponds to a higher accuracy.

Further, it should be noted that the data processing unit 120 can be implemented with a digital signal processor (DSP), and therefore the data filtering unit 126 can be implemented with a software without adding any new electronic components. The system error detecting unit 122 can also be implemented with software. The data processing unit 120 is schematically illustrated in FIG. 1, and should not be restricted as exhibited therein. Further, a format of the positioning data PD satisfies a NMEA communication protocol.

### Second Embodiment

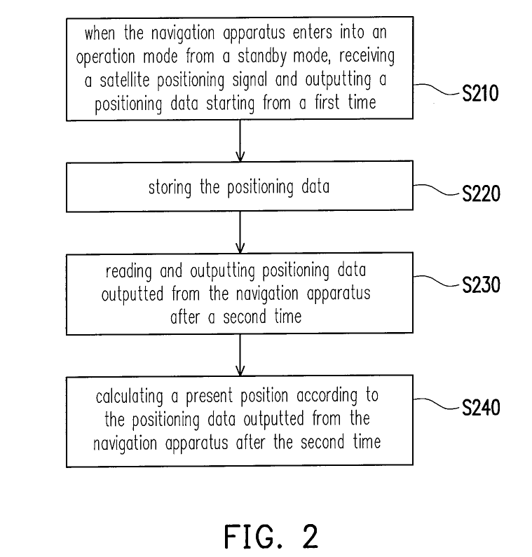

FIG. 2 is a flow chart illustrating a positioning method according to a second embodiment of the present invention. The positioning method is adapted for a GPS navigation apparatus for depressing a position shift. The positioning method includes the following steps. First, at step S210, when the navigation apparatus enters into an operation mode from a standby mode, a satellite positioning signal is received and a positioning data is outputted starting from a first time. Next, at step S220, the positioning data is stored. Next, at step S230, positioning data outputted from the navigation apparatus is read and outputted after a second time, wherein the second time occurs after the first time, and there is a predetermined time interval between the first time and the second time. Next, at step S240, a present position is calculated according to the positioning data outputted from the navigation apparatus after the second time.

Further, according to an aspect of the embodiment, the step S210 further includes calibrating the positioning data outputted from the navigation apparatus, and adjusting a transmitting rate of the positioning data, so as to match transmitting mode between the GPS module and the system. More details thereof can be deduced by referring the description related to the first embodiment, and are not to be iterated hereby.

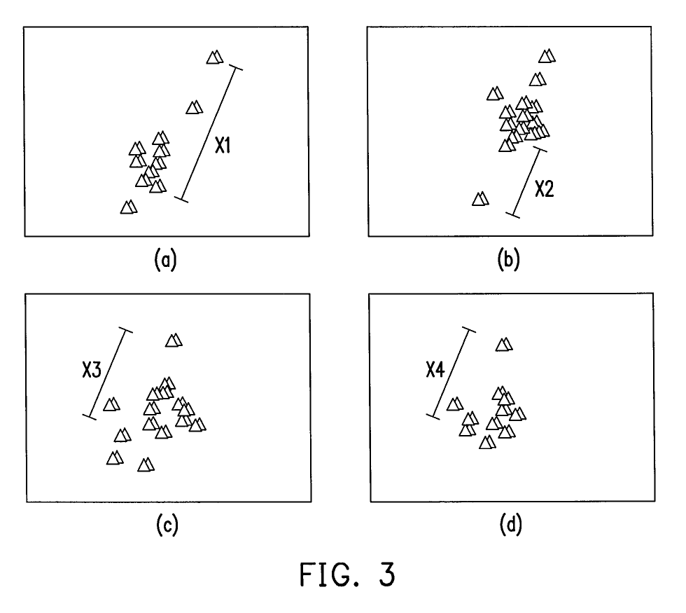

FIG. 3 shows schematic views illustrating the position shift according to the embodiments of the present invention. FIGS. 3(a) through 3(d) are test diagrams illustrating the position shift corresponding to predetermined time intervals of 0, 3, 4, and 5 seconds, respectively. As shown in FIGS. 3(a) through 3(d), when the predetermined time interval is 0 second (directly fetching positioning data which is equivalent to the conventional technology), a maximum error distance X1 is about 175 meters as shown in FIG. 3(a); when the predetermined time interval is 3 second (fetching positioning data from the GPS module, starting from 3 seconds after the GPS module enters into the operation mode), a maximum error distance X2 is about 16 meters as shown in FIG. 3(b); when the predetermined time interval is 4 second (fetching positioning data from the GPS module, starting from 4 seconds after the GPS module enters into the operation mode), a maximum error distance X3 is about 8 meters as shown in FIG. 3(c); and when the predetermined time interval is 5 second (fetching positioning data from the GPS module, starting from 5 seconds after the GPS module enters into the operation mode), a maximum error distance X4 is about 8 meters as shown in FIG. 3(d).

As such, it can be learnt from FIGS. 3(a) through 3(d), that the maximum error distance can be reduced up to less than 16 meters, provided to fetch positioning data PD after 3 seconds, and the maximum error distance can be even reduced up to less than 8 meters, provided to fetch positioning data PD after 4 seconds. Therefore, the predetermined time interval can be adjusted by the user in accordance with the required positioning accuracy.

In summary, according to the present invention, as the positioning data outputted by the GPS module is directly fetched after a predetermined time interval since the GPS module enters into the operation mode for calculating the present position of the navigation apparatus, and therefore the possibility of occurrence of position shift as in the case of the conventional technology may be effectively reduced. At the beginning of entering into the operation mode, the positioning data outputted during the first several seconds by the GPS module is relatively inaccurate, in which an error thereof may be up to hundreds of meters. As such, the present invention is adapted to effectively improve the accuracy of navigation apparatuses. Further, the data filtering unit as set forth in the present invention can be realized with software, and thus the positioning accuracy of the navigation apparatus can be improved without additional hardware cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A global positioning system (GPS) navigation apparatus, comprising:
a GPS module, for receiving a satellite positioning signal and outputting a positioning data starting from a first time when the GPS module enters into an operation mode from a standby mode; and
a data processing unit, coupled to the GPS module, for calculating a present position according to a positioning data outputted after a second time by the GPS module,
wherein the second time occurs after the first time, and there is a predetermined time interval between the first time and the second time.

2. The GPS navigation apparatus according to claim 1, wherein the data processing unit comprises:
a register, for storing the positioning data therein;
a data filtering unit, coupled to the register, for reading and outputting the positioning data outputted after the second time by the GPS module; and
a conversion unit, coupled to the data filtering unit, for calculating the present position according to the positioning data outputted from the data filtering unit.

3. The GPS navigation apparatus according to claim 2, wherein the data processing unit further comprises:
a system error detecting unit, coupled between the GPS module and the register, for calibrating the GPS module and adjusting a transmission rate of the position data.

4. The GPS navigation apparatus according to claim 1, wherein the predetermined time interval is longer than 3 seconds.

5. The GPS navigation apparatus according to claim 1, wherein a format of the positioning data matches a National Marine Electronics Association (NMEA) communication protocol.

6. The GPS navigation apparatus according to claim 1, wherein the navigation apparatus comprises:
a display unit, coupled to the conversion unit, for displaying a positioning picture according to the present position.

7. The GPS navigation apparatus according to claim 1 being incorporated in a mobile phone.

8. A positioning method for depressing a position shift, adapted for a global positioning system (GPS) navigation apparatus, comprising:
receiving a satellite positioning signal and outputting a positioning data starting from a first time when the GPS navigation apparatus enters into an operation mode from a standby mode;
storing the positioning data;
reading and outputting positioning data outputted from the navigation apparatus after a second time, wherein the second time occurs after the first time, and there is a predetermined time interval between the first time and the second time; and
calculating a present position according to the positioning data outputted from the navigation apparatus after the second time.

9. The positioning method according to claim 8, wherein the step of outputting the positioning data further comprises:
calibrating the positioning data outputted from the navigation apparatus; and
adjusting a transmitting rate of the positioning data.

10. The positioning method according to claim 8, wherein the predetermined time interval is longer than 3 seconds.

11. The positioning method according to claim 8, wherein a format of the positioning data matches a National Marine Electronics Association (NMEA) communication protocol.

12. The positioning method according to claim 8, wherein the GPS navigation apparatus is incorporated in a mobile phone.
